(19) United States
(12) Patent Application Publication
(10) Pub. No.: US 2006/0213306 A1
(43) Pub. Date: Sep. 28, 2006

(54) Apparatus for multi-axis rotation and translation

(76) Inventors: Matthew John D. Hayes, Ottawa (CA); Robert G. Langlois, Ottawa (CA); Michael Fralick, Kingston (CA)

Correspondence Address: EVEREST INTELLECTUAL PROPERTY LAW GROUP, P. O. BOX 708, NORTHBROOK, IL, 60065, US

(21) Appl. No.: 11/079,664

(22) Filed: Mar. 14, 2005

(51) Int. Cl. B25J 18/00

(52) U.S. Cl. 74/490.01

(57) ABSTRACT

An apparatus for multi-axis rotation and translation comprises a spherical body, a plurality of roller assemblies each engaging the outer surface of the spherical body, a plurality of actuators for driving said roller assemblies, a frame for supporting the plurality of roller assemblies and the plurality of actuators and translation means for translating the frame along each of three orthogonal axes. The actuators are selectively operated to drive the roller assemblies thereby imparting unlimited angular displacement to the spherical body and rotating the spherical body about any axis passing through its geometric center. The translation means may be operated to translate said spherical body along at least one of said three orthogonal axes. The apparatus is particularly applicable to use as a manipulator with six degrees of freedom (unlimited rotational displacement and translational displacement limited only by the boundaries of the workspace).

### FIELD OF THE INVENTION

The present invention relates to an apparatus for multi-axis rotation and translation of a spherical body.

### BACKGROUND OF THE INVENTION

Manipulators capable of motion in three linear and three angular directions singularly or in any combination are often referred to as “six degrees of freedom” (6DOF) manipulators. They have many applications such as motion simulator platforms, sensor calibration tables, precision aiming devices, machining operations, and material handling. These manipulators have different architectures and can be categorized into serial and parallel configurations.

Serial 6DOF manipulators, such as a six-axis wrist-partitioned serial manipulator, have a relatively simple kinematic structure and do not have any closed kinematic loops. Typically each joint has its own actuator which provides a relatively large range of motion and relatively simple control but have generally poor positioning accuracy and very limited load-carrying capacity (as the majority of the load capacity is taken up by actuators themselves).

Conversely, parallel 6DOF manipulators are architecturally more complex because they are formed with several closed kinematic loops, typically two or more kinematic chains that connect a moving platform to a base, where one joint in the chain is actuated and the other joints are passive. Parallel 6DOF manipulators can support larger loads, position these loads with greater accuracy, are typically lighter, less costly to operate (energy savings) and require less maintenance than serial manipulators. Their limitations are that they are highly coupled, more difficult to control and have very limited ranges of motion.

The most commonly known parallel manipulator is the Stewart (or Stewart-Gough) platform which consists of a movable platform attached to a fixed base with six “legs” which can be characterized as universal-prismatic-spherical kinematic chains. There are two types of Stewart platform, the first being a 3-3 platform (i.e. 3 connecting points on the base, 3 connecting points of the movable platform and two legs intersecting each connecting point via a universal or ball-and-socket joint). The second type of Stewart platform is a 6-3 platform (i.e. six connecting points on the base and three connecting points on the movable platform which join the endpoints of two legs). More recently, 6-6 platforms have been introduced. They are sometimes referred to as modified Stewart platforms although they are geometrically much more complicated.

One such parallel 6DOF manipulator is disclosed in U.S. Pat. No. 5,179,525 (Griffis et al.). This manipulator comprises a movable platform supported about a base platform by a plurality of parallel support legs and is based upon the 3-3,6-3 and 6-6 configurations described previously. While these platforms have excellent structural stiffness, they have the inherent drawback that the degrees of freedom are highly coupled. Thus, when the platform nears its limit of motion in one direction (or degree of freedom), it loses its ability to move in other directions (or other degrees of freedom).

A further disadvantage of the Stewart-type platform is that they often rely upon hydraulic actuators, especially in large scale platforms where the actuators must be able to generate large forces to support gravitational loads.

There are other types of 6DOF manipulators that combine translation and rotation. Newport Instruments, for example, custom makes such platforms which typically consist of a turntable mounted to a universal joint. The universal joint's axes are used to orient the turntable. If the turntable has no angle limits, then the platform offers unlimited rotation about an arbitrary axis. Unfortunately, this axis must be within the angular limits of the universal joint, typically ±30°.

Another type of 6DOF manipulator is disclosed in U.S. Pat. No. 4,908,558 (Lordo et al.) for use as a flight motion simulator. This platform is capable of motion in three linear and three angular directions singularly or in any combination and comprises a spherical rotor element which is moved using magnetic bearings and an induction motor which generates magnetic flux in a stator assembly. While this platform can move with six degrees of freedom, it is very complex, requires a lot of power and is only capable of unlimited roll. Its range of pitch and yaw are limited, as are the ranges of its X, Y and Z translations.

### SUMMARY OF THE INVENTION

The present invention seeks to overcome, or at least mitigate, the limitations of the above-described prior art and/or provide an alternative.

According to a first aspect of an embodiment of the invention, there is provided an apparatus for multi-axis rotation and translation comprising a spherical body having an outer surface and a geometric center, a plurality of roller assemblies each engaging the outer surface, a plurality of actuators for driving said roller assemblies, a frame for supporting the plurality of roller assemblies and the plurality of actuators and translation means for translating the frame along each of three orthogonal axes. The actuators are selectively operated to drive the roller assemblies thereby imparting unlimited angular displacement to the spherical body and rotating the spherical body about any axis passing through the geometric center and the translation means is operated to translate the spherical body along at least one of the three orthogonal axes.

Preferably, each of the plurality of roller assemblies comprises active traction means and passive slip means. The roller assemblies may be omni-wheels each having a main wheel hub for providing traction in a direction perpendicular to a rotation axis passing through a center of the hub and a plurality of peripheral rollers for providing slip in a plurality of directions perpendicular to respective rotation axes of the plurality of peripheral rollers.

According to a second aspect of an embodiment of the invention, there is provided an apparatus for multi-axis rotation comprising a spherical body having an outer surface and a geometric center, a plurality of roller assemblies each engaging the outer surface, a plurality of actuators for driving the roller assemblies and a frame for supporting the plurality of roller assemblies and the plurality of actuators. The actuators are selectively operated to drive the roller assemblies thereby imparting unlimited angular displacement to the spherical body and rotating the spherical body about any axis passing through the geometric center.

### BRIEF DESCRIPTION OF THE DRAWINGS

An embodiment of the invention will now be described by way of example with reference to the accompanying drawings, in which:

FIG. 1 is a perspective view of an embodiment of the invention;

FIG. 2 is a perspective view of part of an embodiment of the invention;

FIG. 3A is a side view of part of an embodiment of the invention;

FIG. 3B is a perspective view of part of an embodiment of the invention;

FIG. 4 is a side view of part of an embodiment of the invention;

FIG. 5 is a detailed sectional view of part of an embodiment of the invention.

### DETAILED DESCRIPTION OF THE INVENTION

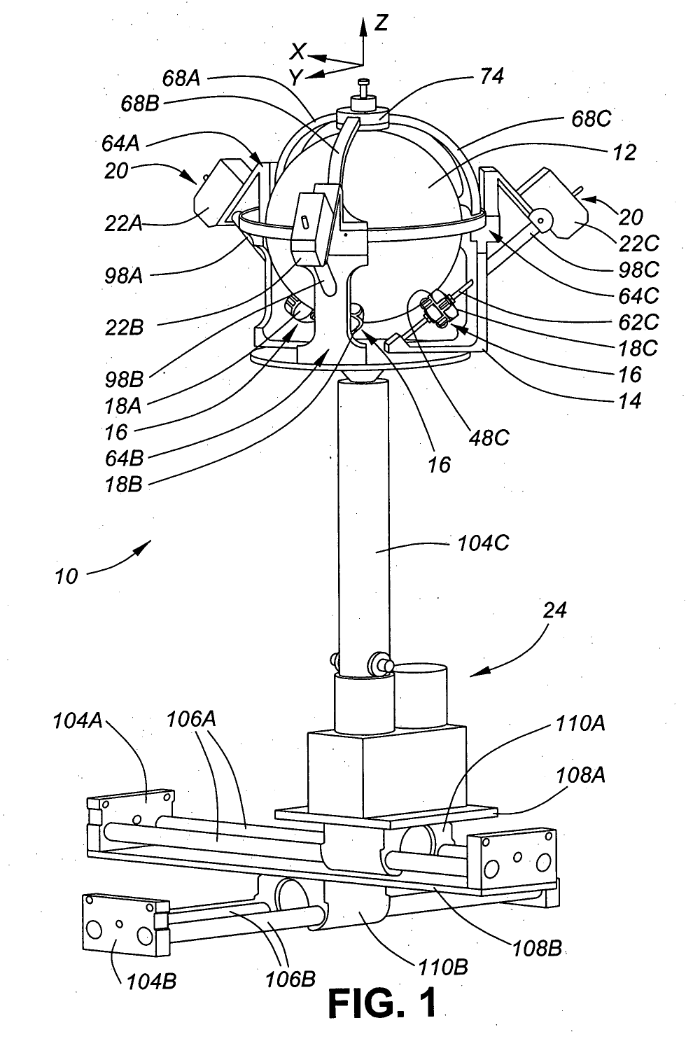

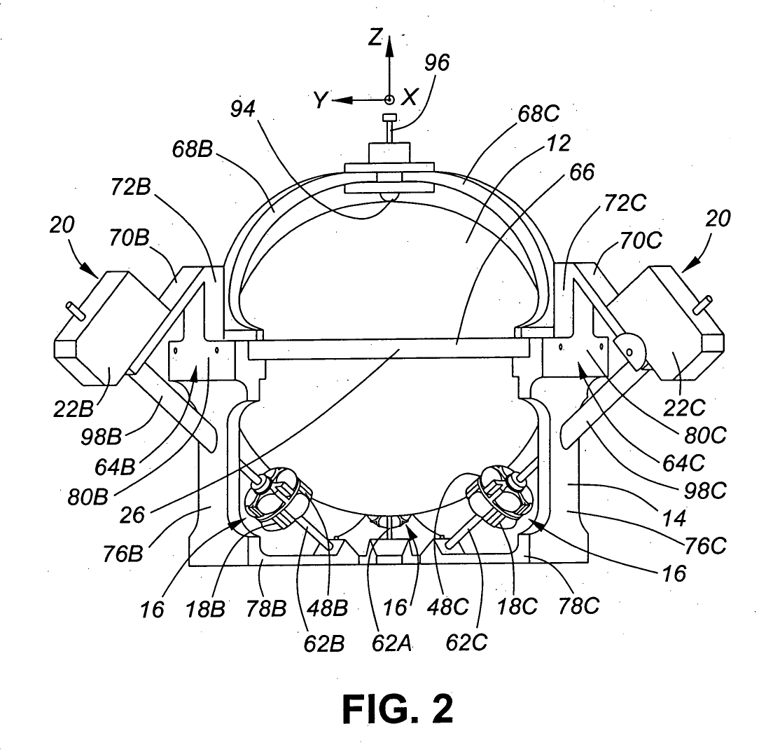

An embodiment of the invention will be described in reference to X, Y and Z axes as indicated in FIGS. 1 and 2. The term “roll” refers to rotation about the X-axis, the term “pitch” refers to rotation about the Y-axis and the term “yaw” refers to rotation about the Z-axis (vertical).

Referring to FIGS. 1 and 2, there is illustrated an apparatus 10 for multi-axis rotation and translation comprising a spherical body 12 supported by a frame 14, a plurality of roller assemblies 16, a plurality of actuators 20 for driving the roller assemblies 16, respectively, and translation means 24. The Z-axis passes through the geometric center 26 of the spherical body 12. The actuators 20 may be of any suitable configuration but as shown are three variable speed DC motors 22A, 22B and 22C.

In the embodiment shown in FIGS. 1 and 2, the roller assemblies 16 comprise three omni-wheels 18A, 18B and 18C. It will be understood by those skilled in the art that there are other configurations of roller assemblies which would meet the design criteria of the invention (as described below). For example, there could be any number of omni-wheels contacting the outer surface of the spherical body 12.

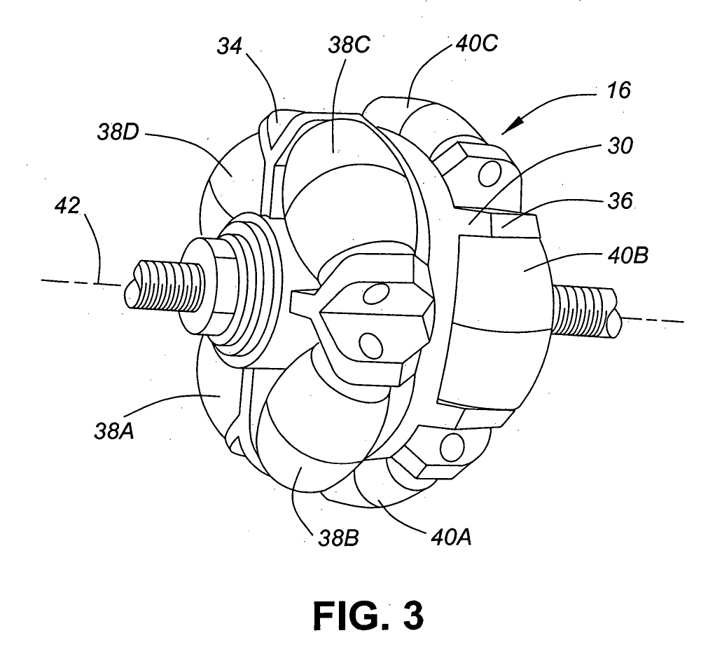

As shown in FIGS. 3A and 3B, the omni-wheels 18A, 18B and 18C (sometimes referred to as “omni-directional” wheels) each comprise a split wheel hub 30 that supports a plurality of passive peripheral rollers 38A, 38B, 38C, 38D, 40A, 40B, 40C and 40D (38D not shown). The split wheel hub 30 has first and second integral hub halves 34 and 36, respectively, each supporting four peripheral rollers 38A, 38B, 38C, 38D and 40A, 40B, 40C, 40D, respectively. Each of the four peripheral rollers 38A, 38B, 38C and 38D of the first hub half 34 is spaced circumferentially between an adjacent pair of the rollers 40A, 40B, 40C and 40D in the second hub half 36. Each of the peripheral rollers is positioned at approximately 90° to the periphery of the wheel hub 30 to allow for near friction-free movement perpendicular to the axis of rotation 42 of the wheel hub. In this way, each of the omni-wheels 18A, 18B and 18C provides traction in a direction perpendicular to the axis of rotation 42 of the wheel hub while permitting slip in a plurality of directions perpendicular to the respective rotation axes 44A, 44B, 44C, 44D, 46A, 46B, 46C and 46D of the rollers 38A, 38B, 38C, 38D, 40A, 40B, 40C and 40D, respectively.

It should be noted that any suitable roller assemblies or other devices that provide the necessary traction and slip may be used. Preferably, each of the roller assemblies will have a substantially circular circumferential profile and will not induce significant vibrations in the spherical body 12.

The three omni-wheels 18A, 18B and 18C contact the spherical body 12 at three points 48A, 48B and 48C, respectively, distributed substantially symmetrically about the Z axis below the reference equator 60 of the spherical body 12 (the reference equator 60 divides the spherical body 12 into two equal parts). The contact points 48A, 48B and 48C of the omni-wheels 18A, 18B and 18C, respectively, are angularly spaced in the XY plane by 120° and form the vertices of an equilateral triangle. This geometry creates equal distribution of static weight of the spherical body 12 on each of the omni-wheels 18A, 18B and 18C.

It should also be noted that the contact points 48A, 48B and 48C of the omni-wheels 18A, 18B and 18C, respectively, do not need to be angularly spaced in the XY plane by 120°. Any suitable angular spacing may be used.

Likewise, while in the above description, the omni-wheels 18A, 18B and 18C engage the spherical body 12 below its reference equator 60, any number of configurations may be used. For example, the omni-wheels 18A, 18B and 18C may be distributed so that the angular spacing of their respective contact points 48A, 48B and 48C is substantially equal in both the XY plane and the XZ or YZ plane (i.e. with at least one of the omni-wheels above the reference equator 60 of the spherical body 12).

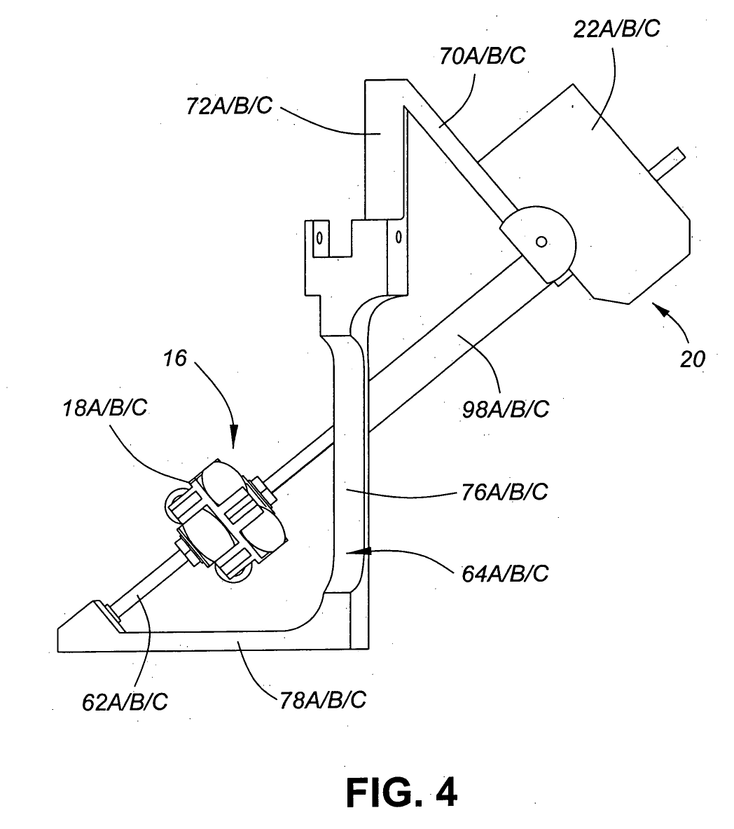

Referring also to FIG. 4, the three variable speed DC motors 22A, 22B and 22C are independently operable so as to rotate at different speeds, or the same speed if desired. Each of the motors 22A, 22B and 22C are coupled to a corresponding one of the omni-wheels 18A, 18B and 18C by corresponding one of three elongate drive pins 62A, 62B and 62C. The motors 22A, 22B and 22C and the drive pins 62A, 62B and 62C are all coupled to the frame 14, as will be explained in more detail below.

The frame 14 comprises three support members 64A, 64B and 64C, an annular member 66, three arcuate members 68A, 68B and 68C, three angled shelves 70A, 70B and 70C, three link arms 72A, 72B and 72C and a coupling 74. The support members 64A, 64B and 64C each have vertical portions 76A, 76B and 76C positioned slightly outwards of the outer surface of the spherical body 12 and extending from the translation means 24 to the height of the geometric center 26 of the spherical body 12. The support members 64A, 64B and 64C also each have horizontal foot portions 78A, 78B and 78C each extending from the lower ends (i.e. distal to the reference equator 60) of the vertical portions 76A, 76B and 76C towards the Z axis. The upper ends (i.e. proximal to the reference equator 60) of the vertical portions 76A, 76B and 76C each engage the annular member 66 at respective connection sites 80A, 80B and 80C.

The annular member 66 has a diameter that is slightly larger than the diameter of the spherical body 12. The three arcuate members 68A, 68B and 68C, each having a radius of curvature slightly larger than the radius of curvature of the outer surface of the spherical body 12, extend upwardly and towards the Z-axis from the connection sites 80A, 80B and 80C and are coupled to the coupling 74 which lies on the Z-axis above the spherical body 12.

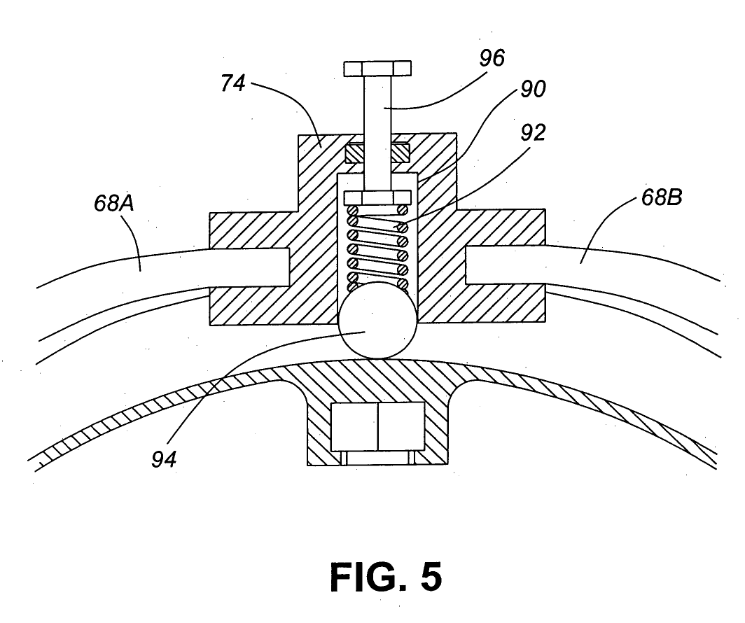

As best seen in FIG. 5, the top of the frame 14 has a bore 90 for slidably receiving a biasing means, shown as a compression spring 92. The compression spring 92 engages a ball bearing 94 which in turn engages the outer surface of the spherical body 12. The compression spring 92 is compressed by a drive rod 96. The compression spring 92, ball bearing 94 and drive rod 96 can be used to manually or automatically apply a force to the outer surface of said spherical body 12. Application of this force increases the normal forces (and therefore the traction) of the omni-wheels 18A, 18B and 18C on the outer surface of the spherical body 12 thus preventing unwanted slippage between the omni-wheels 18A, 18B and 18C and the spherical body 12. The compression spring 92 also allows for any vibrations of the spherical body 12. Of course, the compression spring 92, ball bearing 94 and drive rod 96 may be dispensed with if there is enough traction caused by the weight of the spherical body 12 for the omni-wheels 18A, 18B and 18C to rotate it.

Three hollow cylindrical members 98A, 98B and 98C extend outwardly (away from the Z-axis) and upwardly from the vertical portions 76A, 76B and 76C of the three support members 64A, 64B and 64C, respectively, for telescopically receiving the drive pins 62A, 62B and 62C, respectively. The lower ends of the drive pins 62A, 62B and 62C engage respective horizontal foot portions 78A, 78B and 78C close to the Z-axis. The outermost end portions of each of the three cylindrical members 98A, 98B and 98C each engage respective lower end portions of the three angled shelves 70A, 70B and 70C, upon which the motors 22A, 22B and 22C are supported. Each of the shelves 70A, 70B and 70C is substantially perpendicular to respective one of the cylindrical members 98A, 98B and 98C. The respective upper end portions of the three angled shelves 70A, 70B and 70C are coupled to the annular member 66 by a respective one of three link arms 72A, 72B and 72C extending vertically upwardly from a respective one of the three connection sites 80A, 80B and 80C.

Those skilled in the art would appreciate that any suitable frame or support structure may be used to support the roller assemblies and the actuators without departing from the spirit and scope of the invention.

The horizontal foot portions 78A, 78B and 78C of each of the support members 64A, 64B and 64C are resiliently attached to the translation means 24, which is a set of three independent orthogonal linear translation stages 104A, 104B and 104C for moving the frame in directions parallel to the X, Y and Z axes, respectively. The translation stages 104A and 104B are linear gantry-type translation stages each comprising a pair of parallel rails 106A;106B, a platform 108A;108B and means 110A;110B for moving said platform 108A;108B along said pair of parallel rails 106A;106B. The third translation stage 104C is a vertical prismatic joint actuated by a ball-screw.

It should be noted that the apparatus shown in the drawings could be mounted to or rest on any suitable surface or structure.

Linear combinations of angular displacement and speed of each of the three omni-wheels 18A, 18B and 18C are executed, either manually or automatically (as will be discussed below) to impart the desired angular displacement and speed of the spherical body 12. The motors 22A, 22B and 22C drive each of the omni-wheels 18A, 18B and 18C to execute the desired angular displacement by varying the velocity/force contribution of each omni-wheel so that the rotation axis can be varied to any linear combination of the principal axes. For example, if solely yaw motion is desired, all three omni-wheels are driven in the same direction at the same speed. For solely pitch motion, two of the omni-wheels are driven in opposite directions with equal speed and the third omni-wheel is not actuated, but provides the necessary slip on its passive axis. For solely roll motion, two of the omni-wheels must be driven in the same direction at the same speed, and the third omni-wheel must be driven in the opposite direction at twice the speed of the other two omni-wheels. The overall rotational velocity of the spherical body 12 will also depend upon the weight of the spherical body 12 itself, the relative contributions of each of the omni-wheels 18A, 18B and 18C and their respective contact surfaces.

Simultaneously, the spherical body 12 may be moved parallel to the three translation axes by the translation stages 104A, 104B and 104C. Thus, the rotation and translation are independent of each other, that is to say the rotational and translational actuation are completely decoupled. This means that the spherical body 12 can thus be positioned anywhere within the reachable workspace of the translation stage with any orientation about any axis through the geometric center 26 of the spherical body 12.

It should be noted that those skilled in the art would recognize that any suitable translation means may be used in place of the above-described translation stages 104A, 104B and 104C. In addition, if no translation is desired, i.e. purely rotational displacement, the translation means may be dispensed with altogether.

The spherical body and frame may be made of a rigid material or a non-rigid material.

The motors 22A, 22B and 22C and/or the translation stages 104A, 104B and 104C may be controlled using manual control means or automatic control means. Automatic control means may comprise a computer and motor interface. The computer could calculate the appropriate combination of rotation and translation for a desired movement and send the appropriate signals to the three motors 22A, 22B and 22C and/or the translation stages 104A, 104B and 104C.

While in the above-described embodiment of the invention, no feedback is used (i.e. the apparatus is manually controlled or controlled using open-loop control), feedback may be implemented (i.e. closed-loop control) to adjust the relative contributions of the omni-wheels 18A, 18B and 18C to compensate for deviations from the desired angular displacement of the spherical body 12 and/or discrepancies between the desired angular velocity of the spherical body and the angular velocity of the omni-wheels 18A. 18B and 18C (this effect is sometimes referred to as scrub). For example, optical feedback may be used to determine the angular displacement. Likewise, velocity detection at the omni-wheels 18A, 18B and 18C may be used to determine the angular velocity of the spherical body.

Embodiments of the present invention effectively combine the benefits of both serial and parallel manipulators resulting in a parallel architecture capable of accurate positioning and large load capacity with unlimited range of angular displacement and translational displacement limited only by the translation range of the translation stage(s). Due to the decoupling of the rotational and translational actuation, embodiments of the present invention can be controlled with a high degree of accuracy, and where a computer is used as control means, with relative ease of computation. Effectively, embodiments of the present invention which use a computer as control means provide the computational simplicity of a six-axis wrist partitioned serial manipulator, but have the structural stiffness of a six-legged Stewart-Gough type platform. Due to the unlimited orienting workspace, embodiments of the present invention have an even broader range of applications that the Stewart-Gough type platforms.

In addition, embodiments of the present invention have the additional advantage that the actuators 20 (e.g. standard DC motors 22A, 22B and 22C) do not require as much power as the actuators used in the prior art, namely hydraulic actuators, magnetic bearings and large induction motors. This lower power requirement is also a consequence of having multiple wheel assemblies acting together to actuate the rotational displacement.

Embodiments of the invention are scalable so it is conceivable that the apparatus of the present invention could be applied to large-scale vehicle simulator platforms. Likewise, it is conceivable that the apparatus of the present invention could be scalable to micro scale platforms or smaller.

Embodiments of the invention may also be applied to satellite motion control because of the need for apparatus that operates reliably in the weightlessness of space. In particular, embodiments of the invention can be used to emulate conditions of weightlessness for satellite sensor and control system development, calibration and testing.

While the invention has been described in detail in the foregoing specification, it will be understood by those skilled in the art that variations may be made without departing from the spirit and scope of the invention, being limited only by the appended claims.

What we claim as our invention is:

1. An apparatus for multi-axis rotation and translation comprising:
a spherical body having an outer surface and a geometric center;
a plurality of roller assemblies each engaging said outer surface;
a plurality of actuators for driving said roller assemblies;
a frame for supporting said plurality of roller assemblies and said plurality of actuators; and
translation means for translating said frame along each of three orthogonal axes,
wherein said actuators are selectively operated to drive said roller assemblies thereby imparting unlimited angular displacement to said spherical body and rotating said spherical body about any axis passing through said geometric center and said translation means is operated to translate said spherical body along at least one of said three orthogonal axes.

2. An apparatus for multi-axis rotation and translation according to claim 1, wherein each of said plurality of roller assemblies comprise active traction means and passive slip means.

3. An apparatus for multi-axis rotation and translation according to claim 1, wherein each of said plurality of roller assemblies is an omni-wheel.

4. An apparatus for multi-axis rotation and translation according to claim 3, wherein each of said omni-wheels has a main wheel hub for providing traction in a direction perpendicular to a rotation axis passing through a center of said hub and a plurality of peripheral rollers for providing slip in a plurality of directions perpendicular to respective rotation axes of said plurality of peripheral rollers.

5. An apparatus for multi-axis rotation and translation according to claim 1, wherein each of said roller assemblies engages said outer surface on a same one of two equal parts of said spherical body.

6. An apparatus for multi-axis rotation and translation according to claim 1, wherein said plurality of roller assemblies comprises three omni-wheels.

7. An apparatus for multi-axis rotation and translation according to claim 6, wherein each of said omni-wheels has a main wheel hub for providing traction in a direction perpendicular to a rotation axis passing through a center of said hub and a plurality of peripheral rollers for providing slip in a corresponding plurality of directions perpendicular to respective rotation axes of said plurality of peripheral rollers.

8. An apparatus for multi-axis rotation and translation according to claim 6, wherein said three omni-wheels are angularly spaced by approximately 120° about an axis passing through said geometric center.

9. An apparatus for multi-axis rotation and translation according to claim 1, wherein each of said actuators comprises a motor.

10. An apparatus for multi-axis rotation and translation according to claim 9, wherein said motor is a variable speed DC motor.

11. An apparatus for multi-axis rotation and translation according to claim 9, wherein each of said actuators further comprises a drive shaft coupled to said motor and to one of said plurality of roller assemblies.

12. An apparatus for multi-axis rotation and translation according to claim 1, further comprising means for applying a force to said outer surface.

13. An apparatus for multi-axis rotation and translation according to claim 12, wherein said frame has a bore and said means for applying a force to said outer surface comprises a ball bearing engaging said outer surface, biasing means slidably mounted within said bore acting upon said ball bearing and a drive rod biasing said biasing means thereby applying a force on the ball bearing and communicating said force to said outer surface.

14. An apparatus for multi-axis rotation and translation according to claim 1, wherein said translation means comprises three independent orthogonal linear translation stages.

15. An apparatus for multi-axis rotation and translation according to claim 14, wherein at least two of said translation stages each comprise a pair of substantially parallel rails, a platform for supporting said frame and means for moving said platform along said rails.

16. An apparatus for multi-axis rotation and translation according to claim 1, further comprising control means for controlling said plurality of actuators.

17. An apparatus for multi-axis rotation and translation according to claim 1, wherein said control means also controls said translation means.

18. An apparatus for multi-axis rotation comprising:
a spherical body having an outer surface and a geometric center;
a plurality of roller assemblies each engaging said outer surface;
a plurality of actuators for driving said roller assemblies; and
a frame for supporting said plurality of roller assemblies and said plurality of actuators,
wherein said actuators are selectively operated to drive said roller assemblies thereby imparting unlimited angular displacement to said spherical body and rotating said spherical body about any axis passing through said geometric center.

19. An apparatus for multi-axis rotation according to claim 18, wherein each of said plurality of roller assemblies comprise active traction means and passive slip means.

20. An apparatus for multi-axis rotation according to claim 18, wherein each of said plurality of roller assemblies is an omni-wheel.

21. An apparatus for multi-axis rotation according to claim 20, wherein each of said omni-wheels has a main wheel hub for providing traction in a direction perpendicular to a rotation axis passing through a center of said hub and a plurality of peripheral rollers for providing slip in a plurality of directions perpendicular to respective rotation axes of said plurality of peripheral rollers.

22. An apparatus for multi-axis rotation according to claim 18, wherein each of said roller assemblies engages said outer surface on a same one of two equal parts of said spherical body.

23. An apparatus for multi-axis rotation according to claim 18, wherein said plurality of roller assemblies comprises three omni-wheels angularly spaced by approximately 120° about an axis passing through said geometric center of said spherical body.

24. An apparatus for multi-axis rotation according to claim 18, wherein each of said actuators comprises a motor.

25. An apparatus for multi-axis rotation according to claim 24, wherein each of said actuators further comprises a drive shaft coupled to said motor and to one of said plurality of roller assemblies.

26. An apparatus for multi-axis rotation according to claim 18, further comprising means for applying a force to said outer surface.

27. An apparatus for multi-axis rotation and translation according to claim 18, further comprising control means for controlling said plurality of actuators.
